(19) United States
(12) Patent Application Publication
(10) Pub. No.: US 2026/0309584 A1
(43) Pub. Date: Oct. 8, 2026

(54) TIRE FAILURE DETERMINATION METHOD AND TIRE FAILURE DETERMINATION APPARATUS

(71) Applicant: BRIDGESTONE CORPORATION, Tokyo (JP)

(72) Inventor: Shu KONDO, Chuo-ku, Tokyo (JP)

(73) Assignee: BRIDGESTONE CORPORATION, Tokyo (JP)

(21) Appl. No.: 19/482,247

(22) PCT Filed: Nov. 24, 2023
(86) PCT No.: PCT/JP2023/042268

§ 371 Date: Nov. 7, 2025

(30) Foreign Application Priority Data
May 31, 2023 (JP) 2023-090 188

(51) Int. Cl. G01M 17/02; G01J 5/00; G01J 5/08; G01J 5/48

(52) U.S. Cl. CPC G01M 17/02; G01J 5/0859; G01J 5/48; G01J 2005/0077

(57) ABSTRACT

A tire failure determination method according to the present disclosure is a tire failure determination method to be executed by a computer and includes acquiring a thermal image obtained by imaging a tire with a thermographic camera, determining, based on the thermal image, a relative relationship of surface temperatures acquired for each of a plurality of damaged portions of the tire, and notifying a user of a first alert based on a result of determining the relative relationship.

### TECHNICAL FIELD

The present disclosure relates to a tire failure determination method and a tire failure determination apparatus.

### BACKGROUND

Techniques for determining tire failure are known. For example, PTL 1 discloses a tire damage detection system that detects the size of a damaged portion of a tire based on image data of a tire assembled to a rim wheel, using the diameter of the rim wheel as a reference.

### CITATION LIST

### Patent Literature

PTL 1: JP 2019-202729 A

### SUMMARY

### Technical Problem

However, there is a demand for further improvement in the usefulness of techniques for determining tire failure. For example, in mining vehicles used at mine sites, if a sudden tire failure occurs, productivity decreases due to the occurrence of operations such as transportation by the mining vehicle and tire replacement. Periodic inspection of tires by workers to prevent sudden failures imposes a cost burden. Therefore, automation of tire failure determination is required.

In view of these circumstances, an object of the present disclosure is to provide a tire failure determination method and a tire failure determination apparatus that improve the usefulness of techniques for determining tire failure.

### Solution to Problem

[1] A tire failure determination method according to one embodiment of the present disclosure is a tire failure determination method executed by a computer, comprising: acquiring a thermal image obtained by imaging a tire with a thermographic camera; determining, based on the thermal image, a relative relationship of surface temperatures acquired for each of a plurality of damaged portions of the tire; and notifying a user of a first alert based on a result of determining the relative relationship.

According to the tire failure determination method of one embodiment of the present disclosure, the user can be motivated to inspect more carefully those damaged portions of the tire in the thermal image that have particularly high surface temperatures among the plurality of damaged portions. Conversely, according to the tire failure determination method, the user can be encouraged to simplify or omit inspection of those damaged portions of the tire in the thermal image that have low surface temperatures among the plurality of damaged portions. Therefore, according to the tire failure determination method, the usefulness of techniques for determining tire failure can be improved.
[2] The tire failure determination method according to one embodiment of the present disclosure is the tire failure determination method described in [1] above, wherein the determining of the relative relationship includes determining whether a relatively high outlier exceeding a first threshold is included among the surface temperatures at an identical time point for the plurality of damaged portions. According to the tire failure determination method having such a configuration, it is possible to identify, among the plurality of damaged portions, a damaged portion having a relatively high surface temperature.
[3] The tire failure determination method according to one embodiment of the present disclosure is the tire failure determination method described in [2] above, wherein the notifying of the first alert includes, when it is determined that the outlier is included, encouraging inspection of the damaged portion corresponding to the outlier. According to the tire failure determination method having such a configuration, the user can be made aware of the position of a specified damaged portion among the plurality of damaged portions of the tire, thereby motivating the user to inspect the damaged portion.
[4] The tire failure determination method according to one embodiment of the present disclosure is the tire failure determination method described in any one of [1] to [3] above, wherein the determining of the relative relationship includes determining whether a relatively high outlier exceeding a second threshold is included among changes over time in the surface temperatures of the plurality of damaged portions. According to the tire failure determination method having such a configuration, it is possible to identify, among the plurality of damaged portions, a damaged portion in which the change in surface temperature over time is significant.
[5] The tire failure determination method according to one embodiment of the present disclosure is the tire failure determination method described in any one of [1] to [4] above, further comprising: acquiring an inner cavity temperature of the tire; and estimating a depth for each damaged portion in the plurality of damaged portions based on the surface temperatures in the thermal image and the inner cavity temperature when the thermal image was captured. According to the tire failure determination method having such a configuration, by using the inner cavity temperature of the tire, it is possible to improve the accuracy of estimating the depth of a damaged portion based on the surface temperature of the damaged portion. Therefore, according to the tire failure determination method, the usefulness of techniques for determining tire failure can be improved.
[6] The tire failure determination method according to one embodiment of the present disclosure is the tire failure determination method described in [5] above, wherein the estimating of the depth includes correcting the depth according to a position of the damaged portion in the tire. According to the tire failure determination method having such a configuration, by taking into account the structural characteristics inside the tire, it is possible to further improve the accuracy of estimating the depth of the damaged portion.
[7] The tire failure determination method according to one embodiment of the present disclosure is the tire failure determination method described in [5] or [6] above, further comprising notifying the user of a second alert based on a result of the estimating of the depth. According to the tire failure determination method having such a configuration, it is also possible to inform the user of a guideline for the timing of tire replacement due to failure.
[8] The tire failure determination method according to one embodiment of the present disclosure is the tire failure determination method described in [7] above, wherein the notifying of the second alert includes, when it is determined that the estimated depth is not within an allowable range of durability of the tire, notifying that the tire has failed due to the damaged portion corresponding to the estimated depth. According to the tire failure determination method having such a configuration, it becomes possible to inform the user that it is preferable to replace the tire immediately due to the failure.
[9] A tire failure determination apparatus according to one embodiment of the present disclosure comprises a controller, the controller being configured to acquire a thermal image obtained by imaging a tire with a thermographic camera, determine, based on the thermal image, a relative relationship of surface temperatures acquired for each of a plurality of damaged portions of the tire, and notify a user of a first alert based on a result of determining the relative relationship.

According to the tire failure determination apparatus of one embodiment of the present disclosure, the user can be motivated to inspect more carefully those damaged portions of the tire in the thermal image that have particularly high surface temperatures among the plurality of damaged portions. Conversely, according to the tire failure determination apparatus, the user can be encouraged to simplify or omit inspection of those damaged portions of the tire in the thermal image that have low surface temperatures among the plurality of damaged portions. Therefore, according to the tire failure determination apparatus, the usefulness of techniques for determining tire failure can be improved.

### Advantageous Effect

According to the present disclosure, it is possible to provide a tire failure determination method and a tire failure determination apparatus that can improve the usefulness of techniques for determining tire failure.

### BRIEF DESCRIPTION OF THE DRAWINGS

In the accompanying drawings:

FIG. 1 is a diagram illustrating a schematic configuration of a tire failure determination system;

FIG. 2 is a block diagram illustrating a configuration of a server;

FIG. 3 is a sequence diagram illustrating a first operation of the tire failure determination system;

FIG. 4 is a sequence diagram illustrating a second operation of the tire failure determination system;

FIG. 5 is a diagram illustrating an example of a thermal image obtained by imaging a tire;

FIG. 6 is a graph illustrating how the surface temperatures of a plurality of damaged portions of a tire change over time; and

FIG. 7 is Another Graph Corresponding to FIG. 6.

Hereinafter, a tire failure determination system according to an embodiment of the present disclosure will be described with reference to the drawings. In each drawing, the same reference numerals are assigned to common members and parts. However, it should be noted that the drawings are schematic, and the ratios of the respective dimensions may differ from those in reality.

### Configuration of Tire Failure Determination System

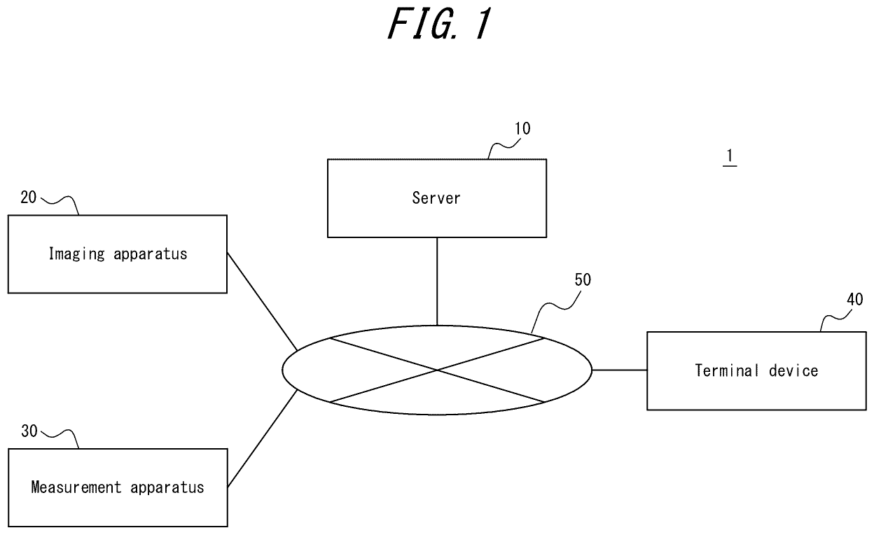

First, with reference to FIG. 1, an overview of the tire failure determination system 1 according to the present embodiment will be described. FIG. 1 is a diagram illustrating a schematic configuration of the tire failure determination system 1. As illustrated in FIG. 1, the tire failure determination system 1 includes a server 10, an imaging apparatus 20, a measurement apparatus 30, and a terminal device 40. In FIG. 1, one server 10, one imaging apparatus 20, one measurement apparatus 30, and one terminal device 40 are illustrated, respectively. However, the tire failure determination system 1 may include any number of servers 10, imaging apparatuses 20, measurement apparatuses 30, and terminal devices 40.

The server 10 is constituted by one or more computers. In the present embodiment, the server 10 will be described as being constituted by a single computer. However, the server 10 may be constituted by a plurality of computers, such as a cloud computing system. In the present disclosure, the server 10 is also referred to as a “tire failure determination apparatus.”

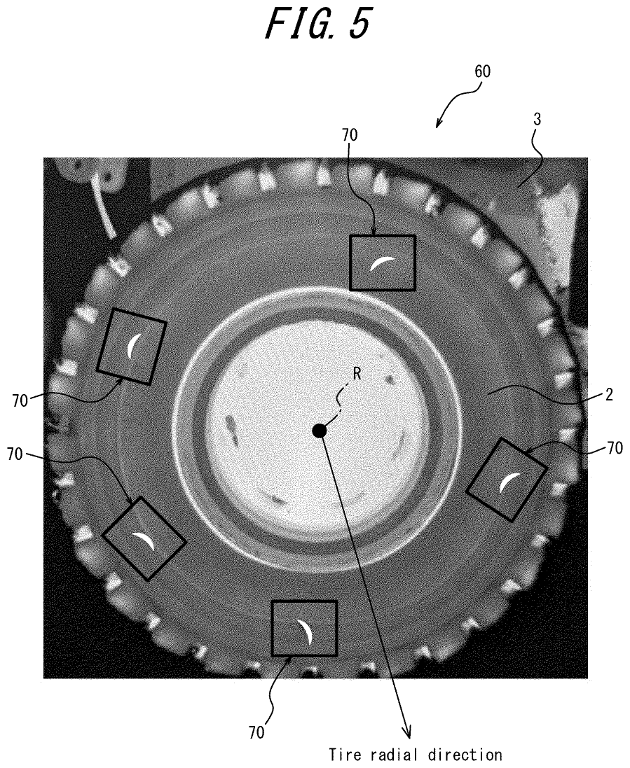

The imaging apparatus 20 is constituted by a computer including one or more cameras. The imaging apparatus 20 is, for example, equipped with a thermographic camera capable of capturing thermal images. However, the imaging apparatus 20 is not limited to a thermographic camera and may be equipped with any camera capable of capturing images, such as a visible light camera or an infrared camera. The images captured by the imaging apparatus 20 may be still images such as photographs, or may be moving images. As will be described later with reference to FIG. 5, the imaging apparatus 20 generates a thermal image 60 of the tire 2 and transmits it to the server 10. In the present embodiment, the thermal image 60 of the tire 2 includes at least a part of the tire 2. The thermal image 60 of the tire 2 may include, in addition to at least a part of the tire 2, at least a part of the vehicle 3 on which the tire 2 is mounted.

Referring again to FIG. 1, the imaging apparatus 20 may, for example, be a fixed imaging apparatus 20 installed along the travel route of the vehicle 3 at a mine site. In this way, the imaging apparatus 20 can capture images of the vehicle 3 traveling along the travel route, making it less likely to reduce the operating rate of the vehicle 3 and productivity at the mine. However, the imaging apparatus 20 is not limited to a fixed imaging apparatus 20 and may be a mobile imaging apparatus 20, such as an imaging apparatus 20 mounted on a drone or a tablet terminal that can be carried by a person.

The measurement apparatus 30 is constituted by a computer including one or more sensors. The sensors may be, for example, a digital tachograph, a tire pressure monitoring system (TPMS: Tire Pressure Monitoring System), an ECU (Electronic Control Unit), or a car navigation device, but are not limited thereto. The measurement apparatus 30 acquires time-series data related to the tire 2 mounted on the vehicle 3 and transmits it to the server 10. Therefore, the measurement apparatus 30 may be installed on the vehicle 3 or the tire 2.

The time-series data related to the tire 2 mounted on the vehicle 3 includes measurement values related to the tire 2 and the measurement date and time, etc. For example, when the measurement apparatus 30 includes a TPMS installed on the tire 2, the measurement values related to the tire 2 may include tire state information of the tire 2, such as the internal pressure (air pressure) of the tire 2, the inner cavity temperature, or the thermal history. The thermal history of the tire 2 is a history of heat applied to the tire 2 during use of the tire 2. The thermal history of the tire 2 is used to evaluate how much energy has been applied to the tire 2 since the start of use. Generally, the greater the thermal history, the more the tire 2 deteriorates. The thermal history may be calculated, for example, by applying the inner cavity temperature of the tire 2 to the Arrhenius equation. For example, when the measurement apparatus 30 includes a digital tachograph installed on the vehicle 3, the measurement values related to the tire 2 may include travel information of the vehicle 3, such as travel time, running distance, speed, acceleration, or the number of rotations of the tire 2.

The terminal device 40 is a computer, such as a smartphone, tablet terminal, or personal computer.

The network 50 is any communication network that allows the server 10, imaging apparatus 20, measurement apparatus 30, and terminal device 40 to communicate with each other. In the present embodiment, the network 50 may be, for example, the Internet, a mobile communication network, a LAN (Local Area Network), or a combination thereof.

The tire failure determination system 1 is used to determine failure of one or more tires 2. In the tire failure determination system 1, the server 10, for example, acquires a thermal image 60 of the tire 2 captured by a thermographic camera from the imaging apparatus 20. The server 10 determines, based on the thermal image 60, the relative relationship of surface temperatures acquired for each of a plurality of damaged portions of the tire 2.

The server 10 acquires time-series data of the inner cavity temperature of the tire 2 from the measurement apparatus 30. The server 10 estimates, for each of the plurality of damaged portions of the tire 2 in the thermal image 60, the depth based on the surface temperatures and the inner cavity temperature at the time the thermal image 60 was captured. In this way, according to the tire failure determination system 1, by using the inner cavity temperature of the tire 2 in addition to the surface temperatures of the plurality of damaged portions of the tire 2 in the thermal image 60, it is possible to estimate the depth of the damaged portions with higher accuracy.

In the present disclosure, the tire 2 is not particularly limited, but may be an OR (Off The Road) tire mounted on a mining vehicle such as a transport vehicle, construction vehicle, work vehicle, or heavy machinery vehicle used at a mine site. However, the tire 2 may be a tire other than an OR tire.

In the present disclosure, the vehicle 3 is, for example, a mining vehicle used at a mine site. However, the vehicle 3 is not limited to the above-described mining vehicle and may be any vehicle capable of mounting the tire 2, such as a transport vehicle, construction vehicle, work vehicle, heavy machinery vehicle, bus, passenger vehicle, motorcycle, bicycle, or airplane.

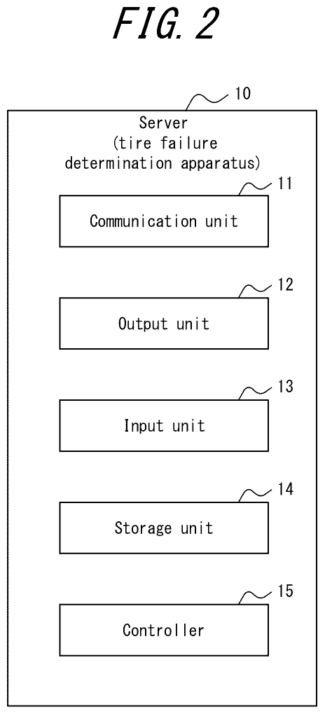

With reference to FIG. 2, the configuration of the server 10, which is the tire failure determination apparatus, will be described in detail. FIG. 2 is a block diagram illustrating the configuration of the server 10. As illustrated in FIG. 2, the server 10 includes a communication unit 11, an output unit 12, an input unit 13, a storage unit 14, and a controller 15. In the server 10, the communication unit 11, output unit 12, input unit 13, storage unit 14, and controller 15 are connected to each other so as to be able to communicate via wired or wireless connections.

The communication unit 11 includes a communication module for connecting to the network 50. The communication module is, for example, a communication module compatible with mobile communication standards such as 4G (4 th Generation) or 5G (5 th Generation). The communication module may also be a communication module compatible with standards such as wired LAN or wireless LAN. The communication module may also be a communication module compatible with near field communication standards such as Wi-Fi®, Bluetooth® (Wi-Fi and Bluetooth are each a registered trademark in Japan, other countries, or both), or infrared communication. In the present embodiment, the server 10 is connected to the network 50 via the communication unit 11. As a result, the server 10 can communicate with the imaging apparatus 20, measurement apparatus 30, terminal device 40, or other computers.

The output unit 12 includes one or more output devices. The output devices are, for example, a display, speaker, or lamp. Thus, the output unit 12 outputs images, sound, light, or the like.

The input unit 13 includes one or more input devices. The input devices are, for example, a touch panel, camera, or microphone. The input unit 13 receives input operations by a user of the server 10, for example.

The storage unit 14 is, for example, a semiconductor memory, magnetic memory, or optical memory. The storage unit 14 functions as, for example, a main storage device, auxiliary storage device, or cache memory. The storage unit 14 stores any information used for the operation of the server 10. For example, the storage unit 14 stores a system program, application program, embedded software, or database. The information stored in the storage unit 14 may be updated with information acquired from the network 50 via the communication unit 11.

For example, the storage unit 14 may store tire identification information for one or more tires 2 to be subjected to failure determination. In the present disclosure, the tire identification information is also referred to as a tire ID (Identifier). The tire identification information of the tire 2 is information that can uniquely identify the tire 2. The tire identification information of the tire 2 is, for example, uniquely assigned by the server 10, but is not limited thereto and may be, for example, the manufacturing number of the tire 2 or the vehicle number of the vehicle 3 on which the tire 2 is mounted. The storage unit 14 may store information related to the tire 2 in association with the tire identification information of the tire 2.

The information related to the tire 2 includes any information related to the tire 2. The information related to the tire 2 may include, for example, the above-described time-series data related to the tire 2, damage information of the tire 2, configuration information of the tire 2, information of the vehicle 3 on which the tire 2 is mounted, or position information of the tire 2 mounted on the vehicle 3. The damage information of the tire 2 may include, for example, information such as the position, shape, depth, and registration date and time of damage previously sustained by the tire 2. The configuration information of the tire 2 may include, for example, the type, model number, material properties, tread pattern, belt angle, size, or weight of the tire 2. The information of the vehicle 3 on which the tire 2 is mounted includes identification information, type, model number, displacement, number of mounted tires, or number of shafts of the vehicle 3.

The controller 15 includes one or more processors. The processor may be, for example, a general-purpose processor such as a CPU (Central Processing Unit), or a dedicated processor specialized for specific processing. The controller 15 is not limited to a processor and may include one or more dedicated circuits. The dedicated circuit may be, for example, an FPGA (Field-Programmable Gate Array) or an ASIC (Application Specific Integrated Circuit). The controller 15 controls each component to realize the functions of the server 10, including the functions of the above-described communication unit 11, output unit 12, input unit 13, and storage unit 14.

### Operation of Tire Failure Determination System

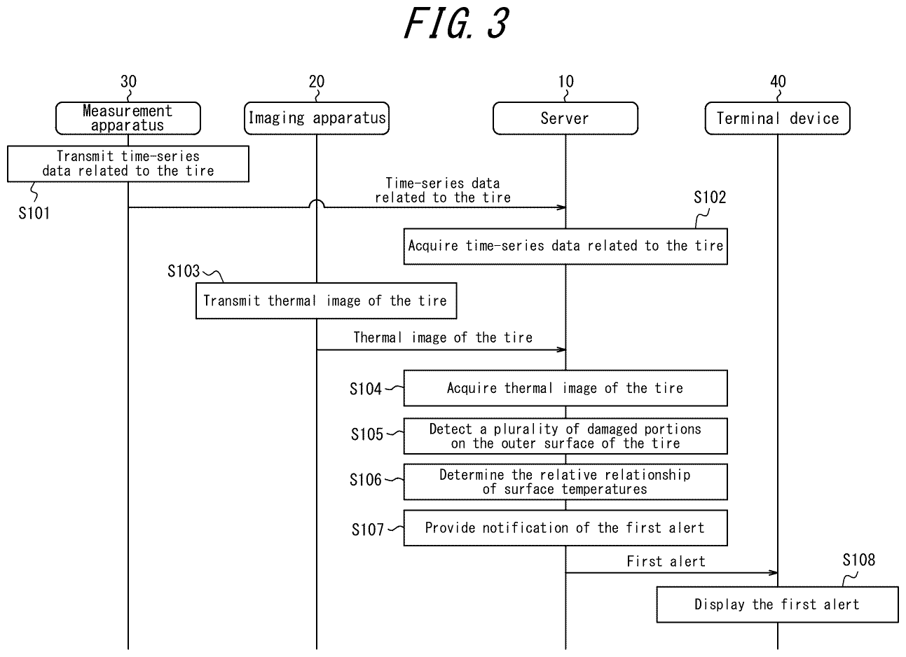

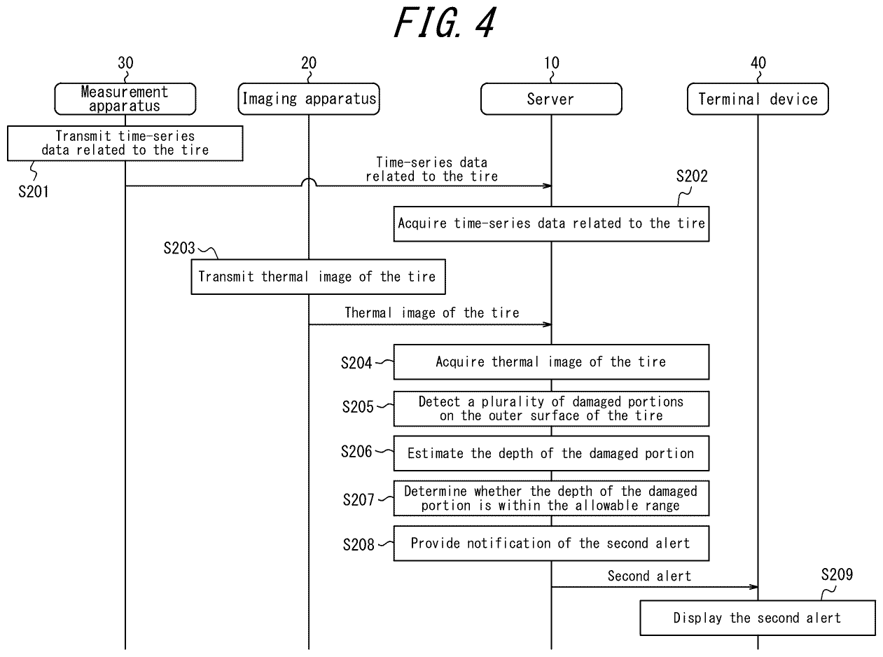

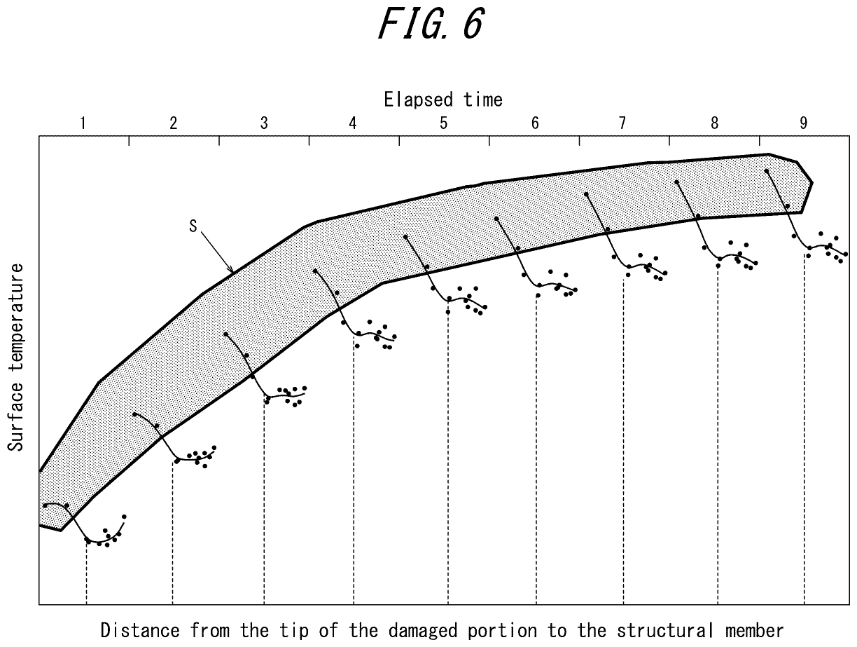

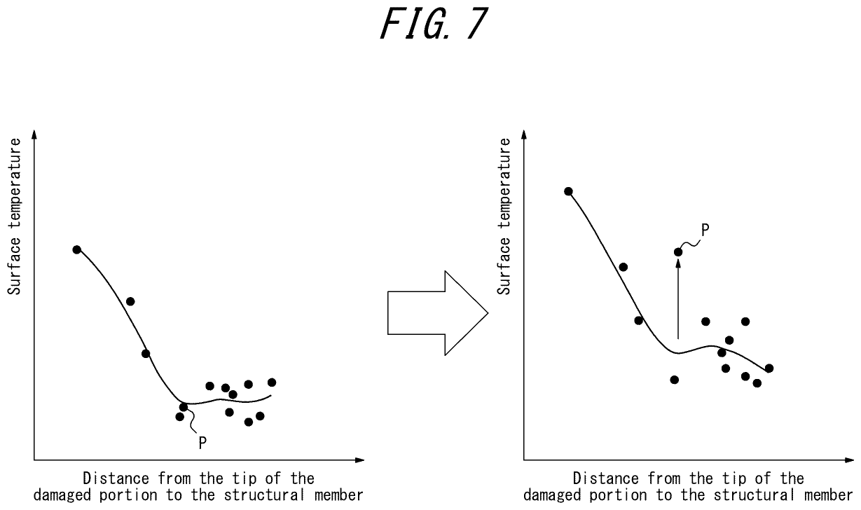

With reference to FIGS. 3, 4, 5, 6, and 7, the operation of the tire failure determination system 1 will be described. FIG. 3 is a sequence diagram illustrating a first operation of the tire failure determination system 1. FIG. 4 is a sequence diagram illustrating a second operation of the tire failure determination system 1. FIG. 5 is a diagram illustrating an example of a thermal image 60 of the tire 2. FIG. 6 is a graph illustrating how the surface temperatures of a plurality of damaged portions 70 of the tire 2 change over time. FIG. 7 is another graph corresponding to FIG. 6.

The sequence diagram illustrated in FIG. 3 presents the operations of the server 10, imaging apparatus 20, measurement apparatus 30, and terminal device 40 included in the tire failure determination system 1. Therefore, the description of this operation corresponds to the tire failure determination method executed by the tire failure determination system 1, as well as to the tire failure determination method executed by each of the server 10, imaging apparatus 20, measurement apparatus 30, or terminal device 40 included in the tire failure determination system 1.

In the description of this operation, it is assumed that the controller 15 of the server 10 stores, in the storage unit 14, the tire identification information of the tire 2 and information related to the tire 2 associated with the tire identification information of the tire 2.

In this operational example, as an example, the operation in which the server 10 detects a plurality of damaged portions 70 on the outer surface of the side portion of the tire 2 based on the thermal image 60 illustrated in FIG. 5 will be described. In such a case, the imaging apparatus 20 may be installed at a position along the travel route of the vehicle 3 at a mine site where it can capture a thermal image 60 of the side surface of the vehicle 3.

Referring to FIG. 3, in step S101, the measurement apparatus 30 acquires time-series data related to the tire 2 mounted on the vehicle 3 and transmits it to the server 10.

Specifically, the measurement apparatus 30 acquires time-series data related to the tire 2 at predetermined timings using sensors. The measurement apparatus 30 may transmit the acquired time-series data related to the tire 2 to the server 10 in association with the identification information of the tire 2. For example, the measurement apparatus 30 may transmit the time-series data to the server 10 each time it acquires time-series data related to the tire 2. Alternatively, the measurement apparatus 30 may transmit, in a batch, the time-series data measured over a predetermined period to the server 10. In this operational example, the measurement apparatus 30 is equipped with a digital tachograph and a TPMS. Therefore, the time-series data related to the tire 2 may include tire state information of the tire 2, such as the internal pressure (air pressure), inner cavity temperature, and thermal history of the tire 2, as well as travel information of the vehicle 3, such as travel time and running distance of the vehicle 3. However, the time-series data transmitted from the measurement apparatus 30 is not limited to the above-described information.

In step S102, the controller 15 of the server 10 acquires time-series data related to the tire 2, including the inner cavity temperature of the tire 2.

Specifically, the controller 15 of the server 10 receives the time-series data related to the tire 2 from the measurement apparatus 30 via the communication unit 11. However, the controller 15 may receive the time-series data related to the tire 2 acquired by the measurement apparatus 30 via a computer other than the measurement apparatus 30. The controller 15 may store the received time-series data related to the tire 2 in the storage unit 14 in association with the identification information of the tire 2.

In step S103, the imaging apparatus 20 transmits a thermal image 60 of the tire 2, captured by a thermographic camera, to the server 10.

Specifically, the imaging apparatus 20 captures an image of the tire 2 using a thermographic camera and generates a thermal image 60 of the tire 2. In this operational example, as illustrated in FIG. 5, the thermal image 60 is described as a single still image, but it may be a plurality of still images or a moving image captured continuously. The imaging apparatus 20 transmits the captured thermal image 60 to the server 10 together with information on the capture time of the thermal image 60. However, the image transmitted from the imaging apparatus 20 is not limited to the thermal image 60. For example, the imaging apparatus 20 may transmit, together with the thermal image 60, a photograph captured by a visible light camera to the server 10. The thermal image 60 of the tire 2 may include, in addition to at least a part of the tire 2, at least a part of the vehicle 3 on which the tire 2 is mounted. In the thermal image 60 illustrated in FIG. 5, a part of the tire 2 and a part of the vehicle 3 on which the tire 2 is mounted are depicted.

Referring again to FIG. 3, in step S104, the controller 15 of the server 10 acquires the thermal image 60 of the tire 2.

Specifically, the controller 15 of the server 10 receives the thermal image 60 of the tire 2 from the imaging apparatus 20 via the communication unit 11, together with information on the capture time of the thermal image 60. However, the controller 15 may receive the thermal image 60 captured by the imaging apparatus 20 via a computer other than the imaging apparatus 20. The controller 15 may store the received thermal image 60 and its capture time in the storage unit 14 in association with the identification information of the tire 2.

Further, in step S104, the controller 15 of the server 10 may identify the tire identification information depicted in the thermal image 60 from the thermal image 60. In this way, even if the tire 2 depicted in the thermal image 60 has not been previously identified, the controller 15 can identify the tire 2 from the thermal image 60. Specifically, the controller 15 extracts a display portion indicating the tire identification information of the tire 2 in the thermal image 60 by image processing. The display portion may be, for example, a two-dimensional code such as a QR (Quick Response) code® (QR code is a registered trademark in Japan, other countries, or both) affixed to the tire 2 or the vehicle 3. In such a case, the controller 15 can read the tire identification information of the tire 2 from the display portion, which is a two-dimensional code. However, the display portion is not limited to a two-dimensional code and may be any display information such as a character string, symbol, figure, color, pattern, or one-dimensional code.

The display portion indicating the tire identification information of the tire 2 may be displayed at any position. For example, the display portion may be provided on the outer surface of the tire 2, such as the side portion of the tire 2. In such a case, even if the tire 2 is re-mounted from one vehicle 3 to another vehicle 3 due to tire rotation or the like, the tire 2 can continue to be identified based on the same display portion. However, the display portion may be provided on the body of the vehicle 3 on which the tire 2 is mounted. In such a case, since the display portion is provided on the body of the vehicle 3, even if the outer surface of the tire 2 becomes dirty with mud or is damaged, the visibility of the display portion is less likely to decrease. In this operational example, the controller 15 of the server 10 is described as identifying the tire identification information depicted in the thermal image 60 from the thermal image 60, but this is not limiting. For example, when a photograph captured by a visible light camera is received together with the thermal image 60 from the imaging apparatus 20, the controller 15 may identify the tire identification information of the tire 2 from this photograph.

Referring again to FIG. 3, in step S105, the controller 15 of the server 10 detects a plurality of damaged portions 70 on the outer surface of the tire 2 depicted in the thermal image 60.

Any method may be adopted for detecting the plurality of damaged portions 70. For example, the controller 15 of the server 10 may store in advance, in the storage unit 14, an image analysis algorithm for identifying the plurality of damaged portions 70 of the tire 2 depicted in the thermal image 60.

Specifically, the controller 15 of the server 10 uses an image analysis algorithm to detect, on the outer surface of the tire 2 depicted in the thermal image 60, portions whose temperature is higher than the surrounding areas by at least a threshold temperature, as damaged portions 70 such as cuts or cracks. Generally, as the vehicle 3 travels, the temperature inside the cavity of the tire 2 rises. The damaged portions 70 on the outer surface of the tire 2 are closer to the cavity of the tire 2 than other areas, and thus have a higher surface temperature. Therefore, the thermal image 60 can be used to detect the position and depth of the damaged portions 70 on the outer surface of the tire 2.

By using the thermal image 60, even when the captured outer surface of the tire 2 is dirty, or when the tire 2 is photographed at night, and the accuracy of damage detection decreases in photographs taken with a visible light camera, the accuracy of damage detection is less likely to decrease. In this operational example, as illustrated in the thermal image 60 depicted in FIG. 5, the controller 15 detects portions with higher temperature than the surrounding areas as damaged portions 70. However, when there are multiple damaged portions 70 on the tire 2, the controller 15 may detect all of the damaged portions 70. The controller 15 may store information such as the positions and number of the detected damaged portions 70 as damage information of the tire 2, in association with identification information of the tire 2, in the storage unit 14.

The threshold temperature used for detecting the damaged portions 70 may be a fixed value, such as 5 degrees, for example. In such a case, the controller 15 of the server 10 can detect, on the outer surface of the tire 2 depicted in the thermal image 60, portions whose temperature is higher than the surrounding areas by at least 5 degrees as damaged portions 70. The threshold temperature may be changed by the controller 15 according to the inner cavity temperature of the tire 2 (or a thermal history calculated from the inner cavity temperature) at the time the thermal image 60 was captured. For this purpose, the controller 15 may store, in advance in the storage unit 14, correspondence information between the threshold temperature and the inner cavity temperature of the tire 2.

In the present embodiment, the image analysis algorithm and the threshold temperature calculation algorithm may be constructed using statistical methods such as machine learning or deep learning. For example, these algorithms may be constructed by statistical methods using, as training data, the thermal image 60 capturing the tire 2 and the damaged portions 70 in the tire 2 identified by a human or the like. In this way, by accumulating training data, the accuracy of detecting the damaged portions 70 on the outer surface of the tire 2 can be improved. However, the image analysis algorithm and the calculation algorithm may include predetermined arithmetic processing not based on statistical methods.

In step S106, the controller 15 of the server 10 determines, based on the thermal image 60, the relative relationship of the surface temperatures acquired for each of the plurality of damaged portions 70 of the tire 2.

Determining the relative relationship in step S106 may include determining whether a relatively high outlier exceeding a first threshold is included among the surface temperatures at an identical time point for the plurality of damaged portions 70 of the tire 2. In the present disclosure, the “first threshold” is defined based on the standard deviation of the surface temperatures of the plurality of damaged portions 70 of the tire 2. For example, the first threshold may be the standard deviation itself, or a value that is two to three times or more the standard deviation, which is standard when determining outliers by statistical methods.

Referring now to FIG. 6, the results of an experimental investigation are presented, indicating how the surface temperatures of a plurality of damaged portions 70 with different positions and depths in the tire 2 change over time. In FIG. 6, the surface temperatures of the plurality of damaged portions 70 in the tire 2 are represented as point clouds for each block of elapsed time, and a fitted graph for the point cloud is represented as a curve. In FIG. 6, as the block number of elapsed time increases from 1, it indicates the passage of time. For example, the time may elapse in fixed intervals of one hour per block, or the time intervals may differ from block to block.

The horizontal axis of the graph depicted in FIG. 6 represents the distance from the innermost tip in the depth direction of the damaged portion 70 in the tire 2 to a structural member such as a carcass ply constituting the tire 2. For example, in block number 1 of elapsed time, eleven points, each indicating the surface temperature of a damaged portion 70, are plotted for each such distance. The distances for the plurality of damaged portions 70 indicated by the eleven points are different from each other. The distance for a point plotted at a predetermined position on the horizontal axis in block number 1 is the same in each subsequent block, and in each block, a point is plotted at the position corresponding to the predetermined position.

As time passes, the surface temperatures of the plurality of damaged portions 70 generally increase. As time passes, the range of variation in the surface temperatures of the plurality of damaged portions 70 tends to widen. The difference between the minimum and maximum values among the surface temperatures of the plurality of damaged portions 70 tends to increase as time passes. However, even in such cases, in each block, the relative positional relationship of the plots regarding the surface temperatures of the plurality of damaged portions 70 is similar to each other. The profile indicating the dependence of the surface temperatures of the plurality of damaged portions 70 on the above distance is similar in each block. In each block, the smaller the above distance, the higher the surface temperature of the damaged portion 70 tends to be.

The controller 15 of the server 10 determines whether a relatively high outlier exceeding the first threshold is included among the surface temperatures of the plurality of damaged portions 70 in the tire 2 at the same time point, that is, in the same block. For example, as illustrated by an example in FIG. 6, if a portion of the plurality of points plotted in each block falls within a relatively high temperature region S, the controller 15 determines that an outlier is included among the surface temperatures of the plurality of damaged portions 70.

The above processing is not limited thereto, and determining the relative relationship in step S106 may include determining whether a relatively high outlier exceeding a second threshold is included among changes over time in the surface temperatures of the plurality of damaged portions 70 of the tire 2. In the present disclosure, the “second threshold” is defined based on the standard deviation of the changes over time in the surface temperatures of the plurality of damaged portions 70 of the tire 2. For example, the second threshold may be the standard deviation itself, or a value that is two to three times or more the standard deviation, which is standard when determining outliers by statistical methods.

Referring now to FIG. 7, a graph in one block of elapsed time depicted in FIG. 6 and a graph in another example after a predetermined time has elapsed from one block are presented. In FIG. 7, as in FIG. 6, the surface temperatures of the plurality of damaged portions 70 in the tire 2 are represented as point clouds at two different times, and a fitted graph for the point cloud is represented as a curve.

In FIG. 6, even as time passes, the relative positional relationship of the plots regarding the surface temperatures of the plurality of damaged portions 70 was similar to each other, but the present disclosure is not limited to such cases. For example, as depicted in FIG. 7, it is also conceivable that only a predetermined point P exhibits a particularly large change over time.

The controller 15 of the server 10 compares the graphs of the surface temperatures of the plurality of damaged portions 70 in the tire 2 at two time points and determines whether a relatively high outlier exceeding the second threshold is included. For example, as illustrated by an example in FIG. 7, if the change over time in the surface temperature at point P plotted at a predetermined position on the horizontal axis is relatively large, the controller 15 determines that an outlier is included among the changes over time in the surface temperatures of the plurality of damaged portions 70.

Referring again to FIG. 3, in step S107, the controller 15 of the server 10 notifies the user of a first alert based on the result of the determination of the relative relationship in step S106. Specifically, the controller 15 of the server 10 generates information regarding the first alert and transmits it to the terminal device 40 via the communication unit 11.

Notifying the first alert in step S107 may include, when it is determined that an outlier is included among the surface temperatures of the plurality of damaged portions 70, encouraging inspection of the damaged portion 70 corresponding to the outlier. Notifying the first alert may further include specifying and presenting the position of the damaged portion 70 in the tire 2 corresponding to the outlier. The position of the damaged portion 70 in the tire 2 may be represented, for example, by the distance from the rotation axis R of the tire 2 in the tire radial direction, as illustrated in FIG. 5. Here, the “tire radial direction” refers to the direction perpendicular to the rotation axis R of the tire 2.

Referring again to FIG. 3, in step S108, the terminal device 40 displays the content of the first alert based on the notification of the first alert in step S107. By confirming the content of the first alert displayed on the terminal device 40, the user can grasp the position of the damaged portion 70 specified by the server 10 among the plurality of damaged portions 70 in the tire 2 and be motivated to inspect the damaged portion 70.

Referring to FIG. 4, in step S201, the measurement apparatus 30 acquires time-series data regarding the tire 2 mounted on the vehicle 3 and transmits it to the server 10. The specific processing content is the same as in step S101 of FIG. 3.

In step S202, the controller 15 of the server 10 acquires time-series data regarding the tire 2, including the inner cavity temperature of the tire 2 and the like. The specific processing content is the same as in step S102 of FIG. 3.

In step S203, the imaging device 20 transmits to the server 10 a thermal image 60 of the tire 2 captured by the thermographic camera. The specific processing content is the same as in step S103 of FIG. 3.

In step S204, the controller 15 of the server 10 acquires the thermal image 60 of the tire 2. The specific processing content is the same as in step S104 of FIG. 3.

In step S205, the controller 15 of the server 10 detects a plurality of damaged portions 70 on the outer surface of the tire 2 depicted in the thermal image 60. The specific processing content is the same as in step S105 of FIG. 3.

In step S206, the controller 15 of the server 10 estimates the depth for each of the plurality of damaged portions 70 on the outer surface of the tire 2 depicted in the thermal image 60.

Any method may be employed for estimating the depth of the damaged portions 70. For example, the controller 15 of the server 10 may estimate the depth of the damaged portions 70 from the surface temperature of the damaged portions 70 of the tire 2 detected in step S205. The controller 15 may store, in advance in the storage unit 14, a depth estimation algorithm for estimating the depth of the damaged portions 70 from the surface temperature of the damaged portions 70 on the outer surface of the tire 2. The controller 15 uses the depth estimation algorithm to estimate the depth of the damaged portions 70 from the surface temperature of the damaged portions 70. The depth of the damaged portion 70 is, for example, the depth corresponding to the portion with the highest temperature among the surface temperatures of the damaged portions 70 of the tire 2.

At this time, in addition to the surface temperature of the damaged portions 70 of the tire 2 in the thermal image 60, the controller 15 may use the inner cavity temperature of the tire 2 included in the time-series data regarding the tire 2 acquired from the measurement apparatus 30 to estimate the depth of the damaged portions 70. More specifically, in estimating the depth of the damaged portions 70 depicted in the thermal image 60, the depth of the damaged portions 70 is corrected to be a different value according to the inner cavity temperature at the time the thermal image 60 was captured. Estimating the depth of the damaged portions 70 in step S206 includes correcting the depth of the damaged portions 70 according to the inner cavity temperature at the time the thermal image 60 was captured. The surface temperature of the damaged portions 70 of the tire 2 changes under the influence of the inner cavity temperature of the tire 2. Therefore, by correcting the surface temperature of the damaged portions 70 using the relative relationship with the inner cavity temperature of the tire 2, the accuracy of estimating the depth of the damaged portions 70 can be improved.

As described above, in order to correct the depth of the damaged portions 70 estimated from the surface temperature of the damaged portions 70 on the outer surface of the tire 2 by the inner cavity temperature of the tire 2, the controller 15 of the server 10 may store, in advance in the storage unit 14, correspondence information between the surface temperature and depth of the damaged portions 70 and the inner cavity temperature of the tire 2. As the vehicle 3 continues to travel and the inner cavity temperature of the tire 2 increases, the deviation between the temperature of the damaged portions 70 and the inner cavity temperature of the tire 2 becomes larger. Therefore, in estimating the depth of the damaged portions 70, the controller 15 may correct the depth of the damaged portions 70 such that the correction amount increases as the inner cavity temperature of the tire 2 at the time the thermal image 60 was captured increases. In this way, by correcting using the relative relationship between the surface temperature of the damaged portions 70 and the inner cavity temperature of the tire 2, the accuracy of estimating the depth of the damaged portions 70 can be improved.

In the present embodiment, the depth estimation algorithm may be constructed using statistical methods such as machine learning or deep learning. For example, the depth estimation algorithm may be constructed by statistical methods using, as training data, the features of the damaged portions 70 of the tire 2 and the depth of the damaged portions 70 measured by a human or the like. In this way, by accumulating training data, the accuracy of estimating the depth of the damaged portions 70 of the tire 2 can be improved. However, the depth estimation algorithm may include predetermined arithmetic processing not based on statistical methods.

Estimating the depth of the damaged portions 70 in step S206 may include correcting the depth of the damaged portions 70 according to the position of the damaged portions 70 in the tire 2. Even for damaged portions 70 of the same depth, the temperature (surface temperature) of the damaged portions 70 may differ depending on the position of the damaged portions 70 in the tire 2. For example, when a turn-up portion of the carcass ply of the tire 2 is present on the inner cavity side of the damaged portion 70, the surface temperature of the damaged portion 70 becomes higher than when it is not present. This is because the heat of the turn-up portion of the carcass ply is transmitted to the damaged portion 70. In this way, for example, due to differences in internal structure such as the thickness of the rubber at the damaged portion 70 or the presence or absence of the carcass ply, the manner in which the inner cavity temperature of the tire 2 is transmitted to the surface of the damaged portion 70 differs. Therefore, by taking into account the structural features inside the tire 2 that differ according to the distance from the rotation axis R of the tire 2 in the tire radial direction, the accuracy of estimating the depth of the damaged portions 70 can be further improved.

The controller 15 may store the estimated depth of the damaged portions 70, as damage information of the tire 2, in association with identification information of the tire 2, in the storage unit 14. When only one damaged portion 70 is detected in the tire 2 depicted in the thermal image 60, the controller 15 may estimate only the depth of the single damaged portion 70 in this step.

In step S207, the controller 15 of the server 10 determines whether the depth of the damaged portion 70 of the tire 2 is within an allowable range of durability of the tire 2.

In the determination in step S207, the allowable range of durability of the tire 2 may be arbitrarily set. For example, the allowable range of durability of the tire 2 may be defined according to the depth of the damaged portion 70 of the tire 2. The controller 15 of the server 10 can determine, for example, that the depth of the damaged portion 70 of the tire 2 is outside the allowable range of durability of the tire 2 when the depth of the damaged portion 70 exceeds a value defined as the allowable range of durability of the tire 2. In this way, the controller 15 of the server 10 can automatically determine, based on the depth of the damaged portion 70 of the tire 2, whether the tire 2 is within the allowable range of durability. When a plurality of damaged portions 70 are detected in the tire 2 depicted in the thermal image 60, the controller 15 may make this determination based on the damaged portion 70 estimated to be the deepest among the plurality of damaged portions 70. Alternatively, the controller 15 may make this determination based on the total value or average value of the depths of the plurality of damaged portions 70.

When a plurality of damaged portions 70 are detected in the tire 2 depicted in the thermal image 60, the controller 15 of the server 10 may determine, based on the relative depths of the plurality of damaged portions 70, whether the depths of the plurality of damaged portions 70 are within the allowable range. Specifically, among the plurality of damaged portions 70 detected in the tire 2, if the depth of any damaged portion 70 is deeper than the other damaged portions 70, it is considered that the progression of that damaged portion 70 is faster. Therefore, when a damaged portion 70 with a relatively greater depth than the other damaged portions 70 is present in the tire 2, the allowable range for the depth of the damaged portion 70 may be set to be more easily exceeded. In this way, the accuracy of determining, based on the depth of the damaged portion 70 of the tire 2, whether the tire 2 is within the allowable range of durability can be further improved.

The allowable range of durability of the tire 2 may be set in multiple stages. For example, the allowable range of durability of the tire 2 may be set in stages such as a level at which the tire 2 needs to be replaced immediately, a level at which the tire 2 needs to be replaced within one month, a level at which the tire 2 needs to be replaced within two months, and so on. As a result, the tire failure determination system 1 can perform different processing, such as transmitting different warning messages as the second alert described below, according to the stage of the allowable range of durability.

In step S208, the controller 15 of the server 10 notifies the user of a second alert based on the estimation result of the depth of the damaged portion 70. Specifically, the controller 15 of the server 10 generates information regarding the second alert and transmits it to the terminal device 40 via the communication unit 11.

Notifying the second alert in step S208 may include, when it is determined that the estimated depth of the damaged portion 70 is not within the allowable range of durability of the tire 2, notifying that the tire 2 has failed due to the corresponding damaged portion 70. For example, notifying the second alert may include notifying a message warning that the tire 2 needs to be replaced immediately.

In step S209, the terminal device 40 displays the content of the second alert based on the notification of the second alert in step S208. The user can recognize that the tire 2 has failed by checking the content of the second alert displayed on the terminal device 40.

The above is not limiting, and notifying the second alert in step S208 may include outputting damage information of the tire 2, including, for example, the position, number, or depth of the damaged portion 70, when it is determined that the damaged portion 70 of the tire 2 is outside the allowable range.

Any method may be adopted for outputting the damage information of the tire 2. For example, the controller 15 of the server 10 may display the damage information of the tire 2 via the output unit 12 such as a display. Alternatively, the controller 15 may transmit a request to display the damage information of the tire 2 to the terminal device 40 via the communication unit 11. In such a case, in step S209, the terminal device 40 can display the damage information of the tire 2 via a display or the like based on the request received from the server 10.

The damage information of the tire 2 may include, for example, the depth of the damaged portion 70 of the tire 2. However, the damage information of the tire 2 is not limited to the depth of the damaged portion 70 of the tire 2, and may include any information such as the position, number, or warning message of the damaged portion 70. As a result, the user of the tire failure determination system 1 can easily grasp the degree of depth of the damaged portion 70 on the outer surface of the tire 2, and can plan inspection, repair, replacement, or the like of the tire 2 before the tire 2 fails.

In particular, when the tire 2 is replaced, the tire 2 may be replaced with a different tire 2 according to the damage information of the tire 2. For example, if the surface temperature of the damaged portion 70 is higher than the durable temperature set for the tire 2, the tire 2 may be replaced with another type of tire 2 having higher heat resistance. Alternatively, if the number of damaged portions 70 is greater than a predetermined number, the tire 2 may be replaced with another type of tire 2 that is less likely to develop damaged portions 70. In this way, the user of the tire failure determination system 1 can select a tire 2 suitable for use at a mine site based on the damage information of the tire 2.

As described above, in the present embodiment, the server 10, which is a tire failure determination apparatus, acquires a thermal image 60 obtained by imaging the tire 2 with a thermographic camera, and determines the relative relationship of the surface temperatures acquired for each of the plurality of damaged portions 70. The server 10 notifies the user of a first alert based on the result of the determination of the relative relationship.

According to such a configuration, the server 10 can motivate the user to inspect more carefully the damaged portion 70 with a particularly high surface temperature among the plurality of damaged portions 70 of the tire 2 in the thermal image 60. Conversely, the server 10 can also encourage the user to simplify or omit inspection of the damaged portion 70 with a low surface temperature among the plurality of damaged portions 70 of the tire 2 in the thermal image 60. Therefore, according to the present embodiment, it is possible to improve the usefulness of the technology for determining failure of the tire 2.

In the above operational example, the operation of detecting the damaged portion 70 on the outer surface of the side portion of the tire 2 in the tire failure determination system 1 has been described, but this is not limiting. The outer surface of the tire 2 to be processed by the tire failure determination system 1 may include at least one of the outer surface of the side portion of the tire 2 or the outer surface of the tread portion. The tire failure determination system 1 may be used to detect the damaged portion 70 on the outer surface of the tread portion of the tire 2 in addition to or instead of the side portion of the tire 2.

In such a case, the imaging apparatus 20 may be installed at a position capable of imaging the front or rear of the vehicle 3 in order to image the tread portion of the tire 2. As in the above-described operational example, the server 10 acquires a thermal image 60 obtained by imaging the tread portion of the tire 2 from the imaging apparatus 20, and acquires the inner cavity temperature of the tire 2. The server 10 estimates the depth of the damaged portion 70 based on the surface temperature of the damaged portion 70 of the tire 2 in the thermal image 60 and the inner cavity temperature at the time the thermal image 60 was captured. As a result, the server 10 can determine the depth of the damaged portion 70 on the outer surface of the tread portion of the tire 2 in addition to or instead of the side portion of the tire 2.

The present disclosure has been described based on the drawings and embodiments, but it should be noted that those skilled in the art can make various modifications and alterations based on the present disclosure. Therefore, it should be noted that such modifications and alterations are included within the scope of the present disclosure. For example, the configurations or functions included in each embodiment can be rearranged so as not to be logically inconsistent. The configurations or functions included in each embodiment can be used in combination with other embodiments, and it is possible to combine multiple configurations or functions into one, divide them, or omit a part thereof.

For example, it is also possible to implement an embodiment in which a general-purpose computer functions as the server 10 according to the above-described embodiment. Specifically, a program describing the processing contents for realizing each function of the server 10 according to the above-described embodiment is stored in the memory of a general-purpose computer, and the processor reads and executes the program. Therefore, the present disclosure can also be realized as a program executable by a processor, or as a non-transitory computer-readable medium storing the program. Examples of non-transitory computer-readable media include magnetic storage devices, optical disks, magneto-optical recording media, or semiconductor memories.

### INDUSTRIAL APPLICABILITY

According to the present disclosure, it is possible to provide a tire failure determination method and a tire failure determination apparatus that can improve the usefulness of the technology for determining failure of the tire 2.

### Contribution to the Sustainable Development Goals (Sdgs) Led by the United Nations

The SDGs have been advocated for the realization of a sustainable society. One embodiment of the present disclosure is considered to be a technology that can contribute to, for example, “No. 9_Build resilient infrastructure, promote inclusive and sustainable industrialization and foster innovation.”

### REFERENCE SIGNS LIST

1: tire failure determination system, 2: tire, 3: vehicle, 10: server (tire failure determination apparatus), 11: communication unit, 12: output unit, 13: input unit, 14: storage unit, 15: controller, 20: imaging apparatus, 30: measurement apparatus, 40: terminal device, 50: network, 60: thermal image, 70: damaged portion, P: point, R: rotation axis, S: temperature region

1. A tire failure determination method to be executed by a computer, the tire failure determination method comprising:
acquiring a thermal image obtained by imaging a tire with a thermographic camera;
determining, based on the thermal image, a relative relationship of surface temperatures acquired for each of a plurality of damaged portions of the tire; and
notifying a user of a first alert based on a result of determining the relative relationship.

2. The tire failure determination method according to claim 1, wherein the determining of the relative relationship includes determining whether a relatively high outlier exceeding a first threshold is included among the surface temperatures at an identical time point for the plurality of damaged portions.

3. The tire failure determination method according to claim 2, wherein the notifying of the first alert includes encouraging inspection of the damaged portion corresponding to the outlier when the outlier is determined to be included.

4. The tire failure determination method according to claim 1, wherein the determining of the relative relationship includes determining whether a relatively high outlier exceeding a second threshold is included among changes over time in the surface temperatures of the plurality of damaged portions.

5. The tire failure determination method according to claim 1, further comprising:
acquiring an inner cavity temperature of the tire; and
estimating a depth for each damaged portion in the plurality of damaged portions based on the surface temperatures in the thermal image and the inner cavity temperature when the thermal image was captured.

6. The tire failure determination method according to claim 5, wherein the estimating of the depth includes correcting the depth according to a position of the damaged portion in the tire.

7. The tire failure determination method according to claim 5, further comprising notifying the user of a second alert based on a result of the estimating of the depth.

8. The tire failure determination method according to claim 7, wherein the notifying of the second alert includes, when it is determined that the estimated depth is not within an allowable range of durability of the tire, notifying that the tire has failed due to the damaged portion corresponding to the estimated depth.

9. A tire failure determination apparatus comprising:
a controller configured to
acquire a thermal image obtained by imaging a tire with a thermographic camera;
determine, based on the thermal image, a relative relationship of surface temperatures acquired for each of a plurality of damaged portions of the tire; and
notify a user of a first alert based on a result of determining the relative relationship.

10. The tire failure determination method according to claim 2, wherein the determining of the relative relationship includes determining whether a relatively high outlier exceeding a second threshold is included among changes over time in the surface temperatures of the plurality of damaged portions.

11. The tire failure determination method according to claim 2, further comprising:
acquiring an inner cavity temperature of the tire; and
estimating a depth for each damaged portion in the plurality of damaged portions based on the surface temperatures in the thermal image and the inner cavity temperature when the thermal image was captured.

12. The tire failure determination method according to claim 3, wherein the determining of the relative relationship includes determining whether a relatively high outlier exceeding a second threshold is included among changes over time in the surface temperatures of the plurality of damaged portions.

13. The tire failure determination method according to claim 3, further comprising:
acquiring an inner cavity temperature of the tire; and
estimating a depth for each damaged portion in the plurality of damaged portions based on the surface temperatures in the thermal image and the inner cavity temperature when the thermal image was captured.
